(19) United States
(12) Patent Application Publication
(10) Pub. No.: US 2023/0116243 A1
(43) Pub. Date: Apr. 13, 2023

(54) ELECTRONIC LOCK AND ACTUATION SENSING METHOD THEREOF

(71) Applicant: TAIWAN FU HSING INDUSTRIAL CO., LTD., Kaohsiung City (TW)

(72) Inventors: Shih-Min Lu, Kaohsiung City (TW); Fu-Chih Huang, Kaohsiung City (TW)

(21) Appl. No.: 17/569,675

(22) Filed: Jan. 6, 2022

(30) Foreign Application Priority Data
Oct. 8, 2021 (TW) 110211881

(51) Int. Cl. E05B 47/00

(52) U.S. Cl. CPC E05B 47/0012; E05B 2047/0069; E05B 2047/0026

(57) ABSTRACT

An electronic lock includes a latch mechanism and a rotation assembly. The rotation assembly includes a rotator, a single sensor and a processor, the rotator can be rotated toward a first direction or a second direction to drive a latch of the latch mechanism to be extended or retracted. The sensor is provided to sense a protrusion, an auxiliary protrusion, a recess and an auxiliary recess of the rotator to output a sensing signal. The processor is electrically connected to the sensor to receive the sensing signal and is provided to distinguish whether an actuation of extension or retraction of the latch is complete according to a potential variation of the sensing signal.

### FIELD OF THE INVENTION

This invention relates to an electronic lock, and more particularly to an electronic lock and its actuation sensing method.

### BACKGROUND OF THE INVENTION

Electronic lock is able to be locked or unlocked by electricity, and recently, user can control and actuate electronic lock remotely via internet owing to Internet of Things (IoT) development. A latch in the electronic lock is actuated to be extended or retracted to lock or unlock the electronic lock, however, user can't know whether the actuation of the electronic lock is complete from external of the electronic lock, it raises a security issue during remote control of the electronic lock. As a result, completing actuation to automatically lock or unlock electronic lock is a major concern. In conventional electronic lock, multiple sensors are required to sense the latch or driver in order to make sure the latch is fully extended or retracted to lock or unlock the electronic lock, but this may lead more power consumption and more errors occurred in the electronic lock caused by the sensors.

### SUMMARY

One object of the present invention is to utilize a single sensor to sense a protrusion and an auxiliary protrusion of a rotator, and an electronic lock can be locked or unlocked accurately by the single sensor.

An electronic lock of the present invention includes a latch mechanism and a rotation assembly. The latch mechanism includes a latch able to be extended or retracted. The rotation assembly includes a rotator, a single sensor and a processor. The rotator is able to be rotated toward a first direction or a second direction to drive the latch of the latch mechanism to be extended or retracted. The rotator includes a protrusion, an auxiliary protrusion, a recess and an auxiliary recess, the auxiliary protrusion is located between the recess and the auxiliary recess, and the auxiliary recess is located between the protrusion and the auxiliary protrusion. The sensor is provided to sense the protrusion, the auxiliary protrusion, the recess and the auxiliary recess to output a sensing signal. During extension or retraction of the latch driven by the rotator, the sensor is used to sense the protrusion, the auxiliary protrusion, the recess and the auxiliary recess so as to output the corresponding sensing signal. The processor is electrically connected to the sensor to receive the sensing signal and provided to determine whether the latch completes actuation of extension or retraction according to a potential variation of the sensing signal.

An actuation sensing method of electronic lock includes the steps as follows. Rotating a rotator of a rotation assembly toward a first direction to actuate a latch of a latch mechanism, the rotator includes a protrusion, an auxiliary protrusion, a recess and an auxiliary recess, the auxiliary protrusion is located between the recess and the auxiliary recess, and the auxiliary recess is located between the protrusion and the auxiliary protrusion. Sensing the protrusion, the auxiliary protrusion, the recess and the auxiliary recess to output a sensing signal by a single sensor of the rotation assembly. Receiving the sensing signal and determining whether the latch completes actuation of extension or retraction according to a potential variation of the sensing signal by a processor of the rotation assembly.

In the electronic lock of the present invention, the potential of the sensing signal of the sensor is varied due to the protrusion, the auxiliary protrusion, the recess and the auxiliary recess of the rotator in rotation. By using the sensing signal of the single sensor, it can ensure complete extension or retraction of the latch of the latch mechanism and improve accuracy and reliability of remote controlling electronic lock.

### DESCRIPTION OF THE DRAWINGS

FIG. 1 is a front view diagram illustrating an electronic lock in accordance with one embodiment of the present invention.

FIG. 2 is a front view diagram illustrating a latch mechanism and a rotation assembly of the electronic lock in accordance with one embodiment of the present invention.

FIG. 3 is a block diagram illustrating a part circuit of the rotation assembly in accordance with one embodiment of the present invention.

FIG. 4 is a perspective exploded diagram illustrating a rotator and a clutch of the electronic lock in accordance with one embodiment of the present invention.

FIG. 5 is a perspective assembly diagram illustrating the rotator in accordance with one embodiment of the present invention.

FIG. 6 is a front view diagram illustrating the relative position of the rotator and a sensor and the status of a latch in accordance with one embodiment of the present invention.

FIG. 7 is a front view diagram illustrating the relative position of the rotator and the sensor and the status of the latch in accordance with one embodiment of the present invention.

FIG. 8 is a front view diagram illustrating the relative position of the rotator and the sensor and the status of the latch in accordance with one embodiment of the present invention.

FIG. 9 is a front view diagram illustrating the relative position of the rotator and the sensor and the status of the latch in accordance with one embodiment of the present invention.

### DETAILED DESCRIPTION OF THE INVENTION

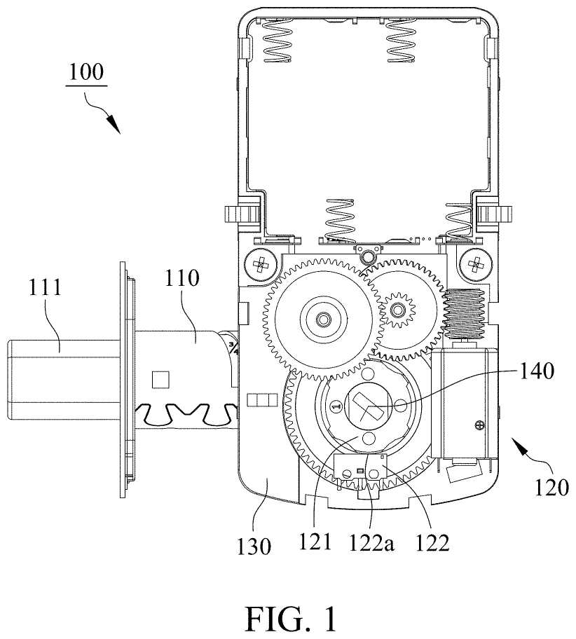

With reference to FIG. 1, an electronic lock 100 in accordance with one embodiment of the present invention includes a latch mechanism 110, a rotation assembly 120 and a housing 130. For simplification, a part of the housing 130 which is located in front of the rotation assembly 120 is not shown in FIG. 1. The rotation assembly 120 is mounted in the housing 130 and connected to the latch mechanism 110 via a driving spindle 140 so the rotation assembly 120 can drive the latch mechanism 110 through the driving spindle 140. In practice, the housing 130 is mounted upon a door panel (not shown) and the latch mechanism 110 is mounted in a latch bore of the door panel. The latch mechanism 110 includes a latch 111 which can be driven by the driving spindle 140 to be extended or retracted, and the driving spindle 140 can be driven by the rotation assembly 120 or by a user through a knob or key. As the latch 111 is extended out, the latch 111 projects from the door panel into a mortise on a door jamb (not shown) and the electronic lock 100 is in a locked status. On the other hand, as the latch 111 is retracted into the latch bore in the door panel, the electronic lock 100 is in an unlocked status.

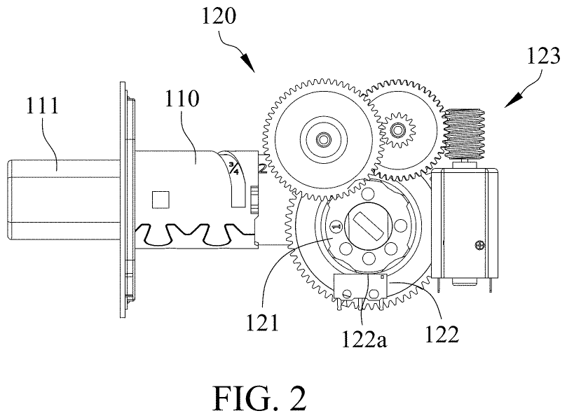

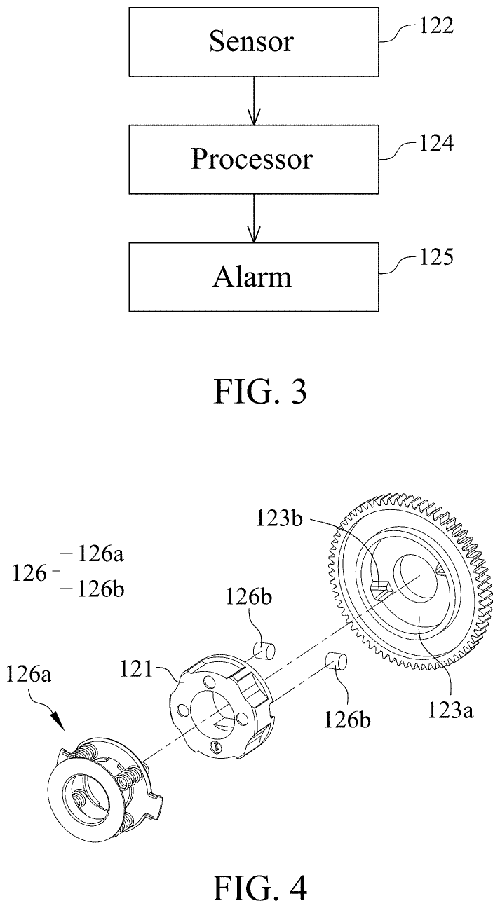

FIG. 2 is a front-view diagram showing a part of the latch mechanism 110 and the rotation assembly 120 of this embodiment and FIG. 3 is a block diagram showing the relation of components in the rotation assembly 120. The rotation assembly 120 includes a rotator 121, a single sensor 122, a driver 123, a processor 124 and an alarm 125. In this embodiment, the driver 123 consists of a motor and at least one gear, the processor 124 is a microprocessor. After receiving an instruction from the user, the processor 124 output a control signal to actuate the motor to rotate the gear such that the rotator 121 is rotated toward a first direction or a second direction. The rotator 121 in rotation can drive the driving spindle 140 and the latch 111 to allow the latch 111 to be extended out or retracted into the door panel. One of the first direction and the second direction is the clockwise direction, and the other one is the counterclockwise direction. Depending on the electronic lock 100 mounted on left or right hand door, rotation of the rotator 121 in one of the first direction and the second direction allows the electronic lock 100 to be unlocked and rotation of the rotator 121 in the other one direction allows the electronic lock 100 to be locked.

With reference to FIG. 4, the gear of the driver 123 is used to rotate the rotator 121 through a clutch 126 in this embodiment. The clutch 126 includes an elastic push plate 126a and two roll components 126b, the elastic push plate 126a is provided to push and secure the rotator 121 within a notch 123a of the gear, and the two roll components 126b are located inside two accommodation grooves on the rotator 121 respectively. Two push components 123b in the notch 123a of the gear are rotated with the gear to push the two roll components 126b such that the rotator 121 is rotated by the two roll components 126b located inside the accommodation grooves. If the rotator 121 is stuck resulted from the driving spindle 140 or the latch 111 which it is connected to during a continuous rotation of the gear, the rotator 121 and the two roll components 126b are pushed by the two push components 123b to be moved toward the elastic push plate 126a and compress multiple elastic components of the elastic push plate 126a such that the two push components 123b can run through the two roll components 126b to allow the motor and the gear to rotate continuously even if the rotator 121 is stuck, and the motor is protected from damage caused by blocking of the rotator 121.

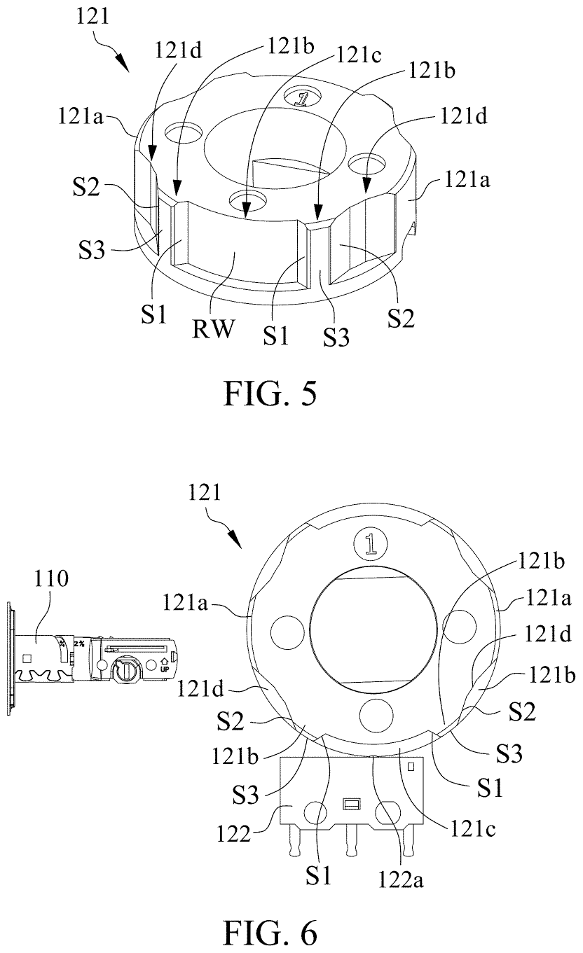

FIG. 5 is a perspective assembly diagram showing the rotator 121 that includes two protrusions 121a, two auxiliary protrusions 121b, a recess 121c and two auxiliary recesses 121d. The recess 121c is located between the two auxiliary protrusions 121b, the two auxiliary protrusions 121b are located between the two protrusions 121a, each of the auxiliary recesses 121d is located between the adjacent protrusion 121a and the adjacent auxiliary protrusion 121b. In this embodiment, for a fool-proof design, the rotator 121 further includes another two auxiliary protrusions at the other side. In fact, only two auxiliary protrusion 121b are required in an electronic lock suitable for left and right hand door, and only one protrusion 121a and one auxiliary protrusion 121b located at the same side are required in an electronic lock suitable for left or right hand door.

With reference to FIG. 6, it is simplified to show only the rotator 121, the sensor 122 and the latch mechanism 110. The sensor 122 is used to sense the protrusion 121a, the auxiliary protrusion 121b, the recess 121c and the auxiliary recess 121d and output a sensing signal to the processor 124, and the processor 124 can distinguish whether actuation of extension or retraction of the latch 111 is complete according to a potential variation of the sensing signal.

In this embodiment, the sensor 122 is a micro switch having a push detection dot 122a where is a sensing position of the sensor 122. When the protrusion 121a or the auxiliary protrusion 121b of the rotator 121 is located at the sensing position of the sensor 122, the protrusion 121a or the auxiliary protrusion 121b pushes down the push detection dot 122a, and at this moment, the sensor 122 output a sensing signal having a first potential. By contrast, as the recess 121c or the auxiliary recess 121d of the rotator 121 is located at the sensing position of the sensor 122, the push detection dot 122a is not pushed and the sensor 122 output a sensing signal having a second potential different to the first potential. As a result, it can be known whether the protrusion 121a and the auxiliary protrusion 121b are located at the sensing position of the sensor 122. According to the design of the sensor 122, one of the first and second potentials is high potential and the other one is low potential.

In other embodiments, the sensor 122 may be photo-interrupter, Hall sensor or other sensing component which can detect whether the protrusion 121a or the auxiliary protrusion 121b of the rotator 121 is located at the sensing position of the sensor 122.

FIGS. 6 to 9 are provided to show the actuation of the latch 111 from fully retracting to fully extending, and they are simplified to shown only the rotator 121, the sensor 122 and the latch mechanism 110 only. While the latch 111 is fully retracted as shown in FIG. 6, the sensing position of the sensor 122 is located at the recess 121c, the push detection dot 122a of the sensor 122 is not pushed and the sensing signal output from the sensor has the second potential.

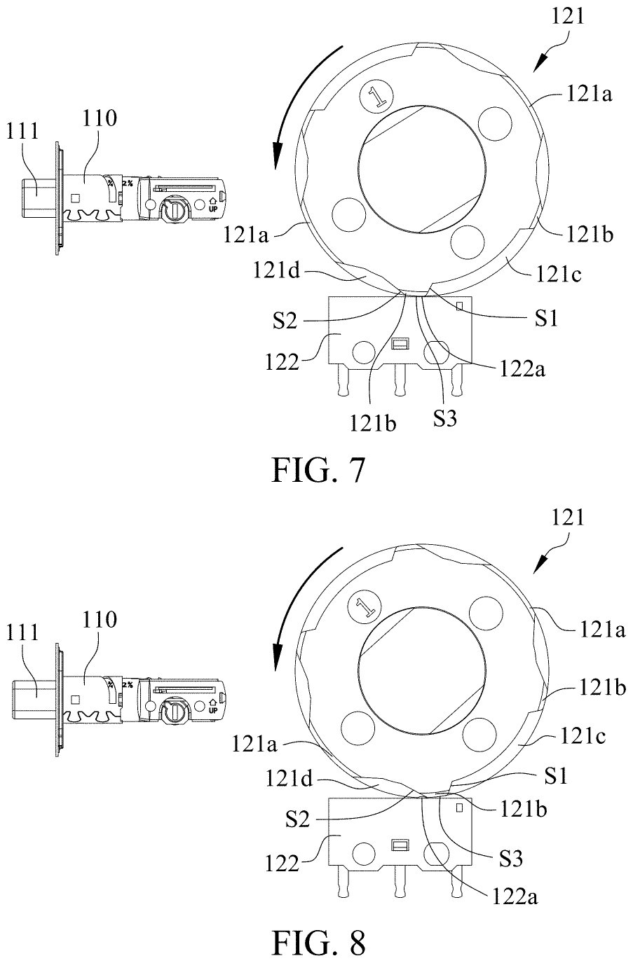

With reference to FIG. 7, as receiving an instruction to lock the electronic lock 100, the processor 124 output a control signal to drive the driver 123 such that the rotator 121 is rotated toward a counterclockwise direction to allow the latch 111 to be extended out. Moreover, the auxiliary protrusion 121b is moved to be located at the sensing position of the sensor 122 to push the push detection dot 122a of the sensor 122 so as to convert the sensing signal output from the sensor 122 from the second potential to the first potential.

As shown in FIG. 8, if the rotator 121 continues to be rotated toward the counterclockwise direction to allow the latch 111 to be extended out, the auxiliary protrusion 121b is moved away from the sensing position of the sensor 122 and then the auxiliary recess 121d is moved to the sensing position of the sensor 122. Thus, the push detection dot 122a of the sensor 122 is not pushed and the sensing signal output from the sensor 122 is converted from the first potential to the second potential.

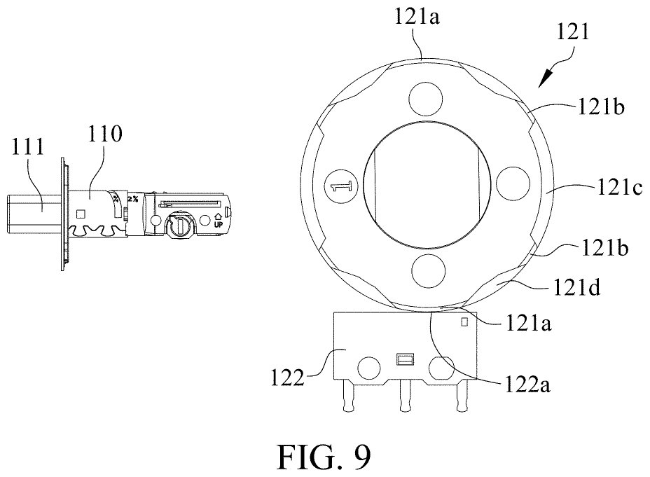

While the latch 111 is fully extended out as shown in FIG. 9, the protrusion 121a is located at the sensing position of the sensor 122 to push the push detection dot 122a of the sensor 122, thereby converting the sensing signal output from the sensor 122 to the first potential from the second potential.

After the processor 124 sends a control signal to control the latch mechanism 110 and lock the electronic lock 100, the processor 124 electrically connected to the sensor 122 can receive the sensing signal from the sensor 122 and determine the latch 111 is actuated or not according to the potential variation of the sensing signal. During extension of the latch 111, the recess 121c, the auxiliary protrusion 121b, the auxiliary recess 121d and the protrusion 121a are moved in sequence through the sensing position of the sensor 122. If the sensing signal, that has a potential variation from the second potential to the first potential, then from the first potential to the second potential, and from the second potential to the first potential in the end, is detected by the processor 124, it is considered that the latch 111 is fully extended in normal actuation. Conversely, if the sensing signal has a potential variation different to the order mentioned above, the latch 111 is considered as having abnormal actuation.

On the other hand, while the latch mechanism 110 is controlled to unlock the electronic lock 100 by the control signal sent from the processor 124, the rotator 121 is rotated in a clockwise direction, and the rotator 121 and the latch 111 are operated in a reverse sequence, as shown from FIG. 9 to FIG. 6 to allow the protrusion 121a, the auxiliary recess 121d, the auxiliary protrusion 121b and the recess 121c to be moved in sequence through the sensing position of the sensor 122. While the electronic lock 100 is unlocked, the processor 124 can determine the retraction of the latch 111 is normal or abnormal according to the potential variation of the sensing signal of the sensor 122. As the sensing signal is detected by the processor 124, which has a potential variation from the first potential to the second potential, then from the second potential to the first potential, and at the last, from the first potential to the second potential, the latch 111 is considered as being actuated normally and retracted fully. Consequently, it can ensure that the retraction of the latch 111 is complete. If the sensing signal has a potential variation different to the order mentioned above, the latch 111 is considered as being actuated abnormally.

With reference to FIG. 3, the alarm 125 of this embodiment is a buzzer, and the processor 124 can send an alarm signal to the alarm 125 to allow the alarm 125 to emit an alarm sound to remind user for trouble shooting while the processor 124 determines the latch 111 is operated abnormally according to the potential variation of the sensing signal. In other embodiments, the alarm 125 can be a mobile application (APP), and the processor 124 can send the alarm signal to the alarm 125 via internet.

Owing to the protrusion 121a, the auxiliary protrusion 121b, the recess 121c and the auxiliary recess 121d provided on the rotator 121, the sensing signal can generate three potential conversions during locking or unlocking the electronic lock 100 so the potential variation can be used to confirm the latch 111 is operated normally or not. Compared to other electronic lock which does not have the auxiliary protrusion 121b and utilizes only one potential conversion caused by the protrusion 121a to detect latch operation, the electronic lock 100 of the present invention has higher accuracy and reliability in detecting latch operation because it can avoid false positive detection of the processor 124 while the latch 111 can't be retracted or extended fully due to the error of the motor, the gear, the driving spindle 140 or the rotator 121. Furthermore, only one sensor 122 is required in detecting whether the latch 111 is fully extended or retracted through the detection process mentioned previously so it is available to reduce power consumption and manufacture cost of the electronic lock 100 and occurrence of actuation error of the electronic lock 100 resulted from the faulty sensor 122.

In this embodiment, the electronic lock 100 is mounted on a right hand door and the protrusion 121a and the auxiliary protrusion 121b at left side of the rotator 121 are provided to push the push detection dot 122a of the sensor 122 to allow the sensor 122 to generate the sensing signal. In other embodiment, the electronic lock 100 is mounted on a left hand door, the latch 111 is extended out while the rotator 121 is rotated in a clockwise direction and retracted back while the rotator 121 is rotated in a counterclockwise direction, and the protrusion 121a and the auxiliary protrusion 121b at right side of the rotator 121 are used to push the push detection dot 122a of the sensor 122 and allow the sensor 122 to generate the sensing signal having the same potential variation as right hand door. The electronic lock 100 of the present invention can be mounted on right or left hand door and installation of the electronic lock 100 is simplified.

With reference to FIG. 5, in this embodiment, two protrusions 121a and two auxiliary protrusions 121b protrude from an external ring wall RW of the rotator 121. Each of the auxiliary protrusions 121b has a first bevel edge S1, a second bevel edge S2 and a connecting surface S3 located between the first bevel edge S1 and the second bevel edge S2, one end of the first bevel edge S1 and one end of the second bevel edge S2 are connected to the external ring wall RW, the other end of the first bevel edge S1 and the other end of the second bevel edge S2 are connected to both ends of the connecting surface S3 respectively. The first bevel edge S1 and the second bevel edge S2 respectively descend and extend toward the external ring wall RW from the end connected to the connecting surface S3 to the other end away from the connecting surface S3, and the slope of the first bevel edge S1 is greater than that of the second bevel edge S2. As shown in FIG. 7, as locking the electronic lock 100, the rotator 121 is rotated in a counterclockwise direction and the auxiliary protrusion 121b is moved toward the push detection dot 122a to allow the first bevel edge S1 to contact the push detection dot 122a, the potential of the sensing signal is varied quickly due to the first bevel edge S1 having greater slope. As shown in FIG. 8, when the auxiliary protrusion 121b is moved across the push detection dot 122a and the second bevel edge S2 is moved away from the push detection dot 122a, the potential of the sensing signal is converted slowly because of the second bevel edge S2 having less slope. Thus, false detection of the processor 124 resulted from the potential of the sensing signal varied too fast can be reduced while the auxiliary protrusion 121b is moved through the sensing position of the sensor 122.

With reference to FIG. 6, the recess 121c is moved to the sensing position of the sensor 122 as the latch 111 is fully retracted. Preferably, the first bevel edge S1 of each of the two auxiliary protrusions 121b is closer to the sensing position than the second bevel edge S2, so no matter the electronic lock 100 is mounted on right or left hand door, the first bevel edge S1 having greater slope is moved to contact the push detection dot 122a of the sensor 122 and then the second bevel edge S2 having less slope is moved away from the push detection dot 122a during the operation of the latch 111 from fully retraction to fully extension to lock the electronic lock 100. It can avoid the sensing signal varied too fast in potential during locking the electronic lock 100 so the accuracy of the processor 124 can be improved in detecting whether the electronic lock 100 is locked normally.

The protrusion 121a, the auxiliary protrusion 121b, the recess 121c and the auxiliary recess 121d are provided on the rotator 121 to induce multiple potential conversions in the sensing signal of the sensor 122. Only the sensing signal of the single sensor 122 is required to distinguish whether the latch 111 of the latch mechanism 110 is extended or retracted fully, so it is available to enhance accuracy and reliable of actuation of the electronic lock 100 as it is controlled remotely.

While this invention has been particularly illustrated and described in detail with respect to the preferred embodiments thereof, it will be clearly understood by those skilled in the art that is not limited to the specific features shown and described and various modified and changed in form and details may be made without departing from the scope of the claims.

What is claimed is:

1. An electronic lock comprising:
a latch mechanism including a latch which is configured to be extended or retracted; and
a rotation assembly including a rotator, a single sensor and a processor, the rotator is configured to be rotated in a first direction or a second direction to drive the latch of the latch mechanism to be extended or retracted, the rotator includes a protrusion, an auxiliary protrusion, a recess and an auxiliary recess, the auxiliary protrusion is located between the recess and the auxiliary recess, the auxiliary recess is located between the protrusion and the auxiliary protrusion, the sensor is configured to sense the protrusion, the auxiliary protrusion, the recess and the auxiliary recess to output a sensing signal, during extension or retraction of the latch driven by the rotator, the sensor is configured to sense the protrusion, the auxiliary protrusion, the recess and the auxiliary recess to output the corresponding sensing signal, the processor is electrically connected to the sensor to receive the sensing signal and configured to determine whether an actuation of extension or retraction of the latch is complete according to a potential variation of the sensing signal.

2. The electronic lock in accordance with claim 1, wherein the sensing signal has a first potential when the protrusion or the auxiliary protrusion of the rotator is located at a sensing position of the sensor, and the sensing signal has a second potential when the recess or the auxiliary recess is located at the sensing position of the sensor, the first potential is different to the second potential.

3. The electronic lock in accordance with claim 2, wherein the potential variation of the sensing signal during extension of the latch is converted from the second potential to the first potential, then converted from the first potential to the second potential, and finally converted from the second potential to the first potential.

4. The electronic lock in accordance with claim 2, wherein the sensing position of the sensor is located at the recess when the latch is retracted fully, and the sensing position of the sensor is located at the protrusion when the latch is extended fully.

5. The electronic lock in accordance with claim 1, wherein the protrusion and the auxiliary protrusion protrude from an external ring wall of the rotator, the auxiliary protrusion includes a first bevel edge, a second bevel edge and a connecting surface, the first and second bevel edges are connected to the external ring wall, the connecting surface is connected to the first and second bevel edges, the first and second bevel edges respectively descend and extend toward the external ring wall from one end connected to the connecting surface to the other end away from the connecting surface, and a slope of the first bevel edge is greater than a slope of the second bevel edge.

6. The electronic lock in accordance with claim 5, wherein the sensing position of the sensor is located at the recess when the latch is retracted fully, and the first bevel edge of the auxiliary protrusion is closer to the sensing position than the second bevel edge of the auxiliary protrusion.

7. The electronic lock in accordance with claim 6, wherein the rotator further includes another auxiliary protrusion and another auxiliary recess, the recess is located between the auxiliary protrusion and the another auxiliary protrusion, and the another auxiliary protrusion is located between the recess and the another auxiliary recess.

8. The electronic lock in accordance with claim 7, wherein the another auxiliary protrusion includes a first bevel edge, a second bevel edge and a connecting surface, the first and second bevel edges of the another auxiliary protrusion are connected to the external ring wall, the connecting surface of the another auxiliary protrusion is connected to the first and second bevel edges, the first and second bevel edges of the another auxiliary protrusion respectively descend and extend toward the external ring wall from one end connected to the connecting surface to the other end away from the connecting surface, and a slope of the first bevel edge is greater than a slope of the second bevel edge.

9. The electronic lock in accordance with claim 8, wherein the sensing position of the sensor is located at the recess when the latch is retracted fully, and the first bevel edge of the another auxiliary protrusion is closer to the sensing position than the second bevel edge of the another auxiliary protrusion.

10. An actuation sensing method of electronic lock comprising:
rotating a rotator of the rotation assembly in a first direction to actuate a latch of a latch mechanism, the rotator includes a protrusion, an auxiliary protrusion a recess and an auxiliary recess, the auxiliary protrusion is located between the recess and the auxiliary recess, the auxiliary recess is located between the protrusion and the auxiliary protrusion;
sensing the protrusion, the auxiliary protrusion, the recess and the auxiliary recess to output a sensing signal by a single sensor of the rotation assembly; and
receiving the sensing signal and determining whether an actuation of extension or retraction of the latch is complete according to a potential variation of the sensing signal by a processor of the rotation assembly.

11. The actuation sensing method of electronic lock in accordance with claim 10, wherein the sensing signal has a first potential when the protrusion or the auxiliary protrusion of the rotator is located at a sensing position of the sensor, and the sensing signal has a second potential when the recess or the auxiliary recess is located at the sensing position of the sensor, the first potential is different to the second potential.

12. The actuation sensing method of electronic lock in accordance with claim 11, wherein the latch is determined to be actuated normally when the potential variation of the sensing signal detected by the processor is converted from the second potential to the first potential, then converted from the first potential to the second potential, and finally converted from the second potential to the first potential, and the latch is determined to be actuated abnormally when the potential variation of the sensing signal detected by the processor is not converted from the second potential to the first potential, then converted from the first potential to the second potential, and finally converted from the second potential to the first potential.

13. The actuation sensing method of electronic lock in accordance with claim 11, wherein after the processor determines the actuation of the latch is normal, the sensing position of the sensor is located at the recess as the latch of the latch mechanism is fully retracted, and the sensing position of the sensor is located at the protrusion as the latch of the latch mechanism is fully extended.

14. The actuation sensing method of electronic lock in accordance with claim 13, wherein the protrusion and the auxiliary protrusion protrude from an external ring wall of the rotator, the auxiliary protrusion includes a first bevel edge, a second bevel edge and a connecting surface, the first and second bevel edges are connected to the external ring wall, the connecting surface is connected to the first and second bevel edges, the first and second bevel edges respectively descend and extend toward the external ring wall from one end connected to the connecting surface to the other end away from the connecting surface, and a slope of the first bevel edge is greater than a slope of the second bevel edge.

15. The actuation sensing method of electronic lock in accordance with claim 14, wherein the sensing position of the sensor is located at the recess when the latch is retracted fully, and the first bevel edge of the auxiliary protrusion is closer to the sensing position than the second bevel edge of the auxiliary protrusion.

16. The actuation sensing method of electronic lock in accordance with claim 15, wherein the rotator further includes another auxiliary protrusion and another auxiliary recess, the recess is located between the auxiliary protrusion and the another auxiliary protrusion, and the another auxiliary protrusion is located between the recess and the another auxiliary recess.

17. The actuation sensing method of electronic lock in accordance with claim 16, wherein the another auxiliary protrusion includes a first bevel edge, a second bevel edge and a connecting surface, the first and second bevel edges of the another auxiliary protrusion are connected to the external ring wall, the connecting surface of the another auxiliary protrusion is connected to the first and second bevel edges, the first and second bevel edges of the another auxiliary protrusion respectively descend and extend toward the external ring wall from one end connected to the connecting surface to the other end away from the connecting surface, and a slope of the first bevel edge is greater than a slope of the second bevel edge.

18. The actuation sensing method of electronic lock in accordance with claim 17, wherein the sensing position of the sensor is located at the recess when the latch is retracted fully, and the first bevel edge of the another auxiliary protrusion is closer to the sensing position than the second bevel edge of the another auxiliary protrusion.
